(19) United States
(12) Patent Application Publication
(10) Pub. No.: US 2011/0239346 A1
(43) Pub. Date: Oct. 6, 2011

(54) Microclimate System for Protective Body Armor

(76) Inventors: Brian Doherty, Melbourne Beach, FL (US); Erby J. McCall, Palm Bay, FL (US); John A. McMorris, Indialantic, FL (US)

(21) Appl. No.: 13/080,531

(22) Filed: Apr. 5, 2011

Related U.S. Application Data
(60) Provisional application No. 61/320,925, filed on Apr. 5, 2010.

(51) Int. Cl. F41H 1/02; B32B 3/12

(52) U.S. Cl. 2/2.5; 428/117

(57) ABSTRACT

A constant or controlled temperature microclimate protective system capable of providing either cooling or heating. Such a system may be used alone or in combination with protective armor without degrading the force impact integrity of the protective system. When used alone, the microclimate system of the present invention may be constructed into a garment configuration for personal use or a sleeve-type configuration for use with one or more electronic devices. When used in combination, the microclimate system may be integrally incorporated into a protective armor system, releasably attached or held within the protective armor system by means including but not limited to a pocket or pouch, or worn as a separate element underneath a protective armor system. The microclimate system may comprise a plurality of cells containing phase change material providing one or more transition temperature points while further assisting in impact shock attenuation.

### CROSS REFERENCE TO RELATED APPLICATIONS

This application claims the benefit of provisional patent application Ser. No. 61/320,925, filed with the USPTO on Apr. 5, 2010, which is herein incorporated by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention relates to a system and method providing effective microclimate control for personal or personnel protective garments including personal body armor, flak jackets, and the like, as well as protective sheathing for critical equipment, wherein the system and method for microclimate control may also synergistically enhance the armor's impact force mitigation capabilities without adversely affecting physical function or range of motion.

2. Background Art

Safety personnel, police/security, military and other hazardous duty personnel use different forms of protective garments/systems to mitigate both high and/or low force impacts from a wide range of potential threats and typically suffer the challenge of considerable heat build-up while wearing such protective gear. They also use such protective gear to protect critical equipment, including tactical radios and various computer or electronic equipment.

As is known in the art, low velocity projectiles such as handgun rounds, fragmentation rounds from a grenade or mortar, and miscellaneous shrapnel may be countered by “soft armor” typically found in the form of jackets, vests, and the like comprising assemblies of ballistic fabric including but not limited to polyaramidpoly (phenylene diamineterephthalamide) as sold by DuPont under the registered name of KEVLAR with or without optional ceramic tile inserts, other aramid fiber cloth, and/or SPECTRA SHIELD high molecular weight polyethylene filaments in a flexible resin matrix. Such sheets may be bound together by several means that include in a coupled matrix, in assemblies of many loose sheets, or sewn together in the manner of quilting. It isn't unusual to encounter protective layers comprising as many as sixty (60) sheets of ballistic fabric.

More recently, as discussed in U.S. Pat. No. 7,498,276 and others, advances in materials science have led to the incorporation of fabrics impregnated with shear thickening fluid, creating a ballistic assembly that is more flexible and less bulky than those comprising conventional ballistic fabric. This process enhances wearer mobility but still creates a negative affect producing heat build-up experienced by the wearer.

Where higher velocity ordnance must be countered, soft armor is typically supplemented with hard armor fabricated into rigid plates of ceramic, polymer, or metal. Unfortunately, such armor is large, heavy, and often interferes with the wearer's mobility while also creating additional heat load.

Regarding force impact performance, to lend a better understand of the superior approaches embodied by the present invention, it is worth briefly reviewing the conventional meaning of terms used in this art. In mechanics, an impact is a high force or shock applied over a short time period when two or more bodies collide. Such a force or acceleration usually has a greater effect than a lower force applied over a proportionally longer time period of time. The effect depends critically on the relative velocity of the bodies to one another.

At normal speeds, during a perfectly inelastic collision, an object struck by a projectile will deform, and this deformation will attenuate most, or even all, of the force of the collision. Viewed from the conservation of energy perspective, the kinetic energy of the projectile is changed into heat and sound energy, as a result of the deformations and vibrations induced in the struck object. However, these deformations and vibrations cannot occur instantaneously. A high-velocity collision (an impact) does not provide sufficient time for these deformations and vibrations to occur. Thus, the struck material behaves as if it were more brittle than it is, and the majority of the applied force goes into fracturing the material. Or, another way to look at it, is that materials involved in an impact are actually more brittle on short time scales than on long time scales; this is related to time-temperature superposition.

Different materials can behave in quite different ways in impact when compared with static loading conditions. Ductile materials like steel tend to become more brittle at high loading rates, and spalling may occur on the reverse side to the impact if penetration doesn't occur. While such spalling isn't a consideration at low loading rates, the way in which the kinetic energy is distributed through a section is quite important in determining its response. At the point of impact to a solid body, projectiles apply a contact stress at the point of impact with compression stresses under the point, but with bending loads a short distance away. Since most materials are weaker in tension than compression, this is the zone where cracks tend to form and grow.

In protective systems that include an outer shell or layer, some of the force of an impact is distributed throughout the shell which, in turn, transfers energy to the layer or liner directly underneath (whether this secondary layer is another protective garment layer, an article of clothing, the wearer's body, or the like). This second layer is capable of absorbing more energy if the impact's force is first distributed over a greater area, which, itself, makes it possible to transmit less energy to this next layer of a system. To the extent that the outer shell or layer is unable to deflect a blow in the area of the impact, the energy will be transferred to the underlying material in a more localized manner, resulting in a high force per unit of area that is likely to cause greater injury than if the force were more distributed. Said differently, the stiffer the outer shell, the better it can distribute a point load of impact over the shape of the protective garment, allowing the next layer to more gracefully attenuate the energy resulting from the impact.

If this next (secondary) layer is optimized to attenuate or dissipate energy, whether by incorporating an effective foam cell design, using multiple integrated responsive layers, or other techniques, it will deform or crush upon impact thereby consuming a portion of the impact energy so that the force per unit area is decreased for the underlying body part (or tertiary garment layer) compared to that experienced by the initial impact surface. Such properties give protective armoring garments enhanced force impact performance, largely true even if the second layer includes slits or seams. This said, it should be recognized that materials capable of providing impact protection at certain speeds generally provide inadequate protection at other speeds. For example, rigid or non-resilient materials may be effective at protecting the wearer at high impact speeds but are almost wholly ineffective at absorbing the impact energy of low speed impacts. To be effective at mitigating force impact in personnel protective garment applications requires the integration of several layers, approaches and/or technologies, including the ability to incorporate layers with different moduli of compression.

A protective system designed to spread the force of impact across a broader area, and which effectively considers ambient environment and then integrates multiple technologies or approaches to spreading and attenuating this energy, is more effective at providing protection to the wearer than a garment which does not spread the force of impact. In addition, careful consideration must be given to the typical ambient temperature range used for a given protective system, of the elastic modulus of each layer of a protective system throughout this temperature range, and the effective integration of multiple layers has the potential to provide even better force impact protection to the wearer or other object protected.

Since liquids are essentially incompressible, the deformation of a liquid filled cell, and its potential to absorb incident impact when struck, is reliant upon the material characteristics of the cell walls (including seals or seams, if present). It is the deformation capacity of the cell walls, even to the point of partial or complete cell destruction that is principally responsible for the attenuation of impact energy in a liquid filled cell. A system of such cells will transmit a lateral shockwave in response to an impact, further distributing the shock energy resulting from the deformation of one or more liquid filled cells thereby effectively spreading the impact over a larger area.

None of this, however, considers the integration of effective microclimate control into a protective garment. Heretofore, it has not been possible to integrate both state of the art force impact protection and state of the art microclimate control in a system or light garment that still affords necessary flexibility and range of motion.

It is known that protective layers may create significant additional heat for the wearer or object protected both because the ballistic protective layers are good thermal insulators and they interfere with the body's cooling efforts by blocking the evaporation of perspiration. Moreover, some soft body armor absorbs perspiration placing an even heavier weight load on the wearer and degrading the armor's ballistic properties. This problem is exacerbated by the addition of hard armor, which creates both additional weight (causing the wearer's body to work harder) and an even higher insulative effect.

The thermal burden created by prolonged wearing of protective apparel/gear becomes exacerbated the longer the individual wears the protective layers, especially in hot, humid environments. Such exposure causes a number of negative physiological responses, including but not limited to increased heart rate, blood pressure, blood flow, and perspiration wherein hyperactivity of the body's vitals is occurring in an attempt to establish thermal regulation and achieve normothermia (the body in balance). Under heavy physical activity (or metabolic load), the body can burn as much as 425 calories per hour, substantially increasing the concomitant activity of the body's vitals at the cellular level. The longer this imbalance occurs, the greater the associated risks of heat related injury that begin at the cellular level and (if uncorrected) proceed to the macroscopic level. With continued imbalance, an individual suffers reduced energy level, stamina, mental acuity and vigilance, and finally in severe cases, the deleterious effects of heat related illness.

It is known in the art that providing effective cooling or heating to the wearer's body before, during, or after exertion can significantly enhance overall stamina, physical performance, mental acuity, and wearer safety (against trauma such as heat exhaustion, hyperthermia, hypothermia, and the like). The human body is capable of delivering extended physical performance and recovers much more quickly when not subjected to thermal stress. Nike, for instance, while studying the effects of heat build-up and cooling on athletes found that using pre-competition cooling for an hour helps to mitigate the adverse effects of subsequent heat built-up, allowing an athlete to last up to 21% longer on the field. The Air Force Test and Evaluation Center (AFOTEC) and Alamo Research Laboratory have performed studies corroborating these results. When firefighters used cooling vests they experienced a 22% increase in work time capability with no significant change in core body temperatures, blood pressure, or heart rates.

Unfortunately, most efforts to create protective garments mitigating wearer microclimate effects suffer from profound disadvantages when used in protective applications, including: adding too much weight to the wearer (thereby reducing stamina and adding to heat load), overly restricting the wearer's range of motion, requiring proximal connection to ancillary systems (to enable recirculation, for instance), and creating a sub-optimal microclimate temperature and thermal consistency when viewed from the perspective of either ambient temperature or what is considered safe for long-term use in close proximity to the body. It is well documented, for instance, that overly cold temperatures such as can be created by ice or gels cause vasoconstriction and reduced capillary flow, which ultimately overwhelms the body's own internal cooling systems and can later precipitate dangerous overheating. While ice and gels (the most common cooling systems) have been around for generations, constant cooling devices (whether set for single or multiple stable transitions) have not. A constant cooling device would work to keep the operational temperature at or approximately at a preset or given temperature and could be elevated well above the ice and/or gel associated temperatures, providing all the benefits of cold therapy without the associated risks such as frostbite, histamine and aqueous production.

Beyond the thermal challenges already disclosed, the incorporation of commercially available personal microclimate technologies into protective garments can degrade the armor's force impact capabilities, which obviously is a critical problem. As a result, recent efforts to mitigate heat build-up in protective garments have taken several new approaches. U.S. Pat. No. 6,363,527 describes means to incorporate thermal conductive material to help transfer heat away from the wearer's body surface. It also discusses means to help wick moisture away from the wearer's body. U.S. Pat. No. 6,892,392 describes the use of pads in between the wearer and the vest/armor to create air channels. Yet, none of these techniques enables the establishment or maintenance of an effective personal microclimate. Both of the prior art approaches are significantly less effective in a high humidity ambient environment, and they fail to address the underlying problem of heat build-up over time.

The encapsulation of non-compressible cooling or warming materials, including gels and appropriate Phase Change Materials (PCMs), may help obviate many or all of these microclimate challenges including the ability to work effectively in high humidity ambient environments. PCMs afford an additional benefit in that they establish a near-constant microclimate temperature until the PCM is fully discharged.

As is known in the art, there are a wide range of available PCMs. PCMs comprise substances with a high heat of fusion that melt and solidify at a certain temperature and are capable of storing and releasing large amounts of energy. Heat is absorbed or released when the material changes from solid to liquid, making PCMs an optimum latent heat storage material.

As is also known, while PCM latent heat storage can be achieved through all forms of chemical transition (e.g. solid-solid, solid-liquid, solid-gas, and liquid-gas phase change), the only phase change of practical use in most applications is the solid-liquid phase change. Liquid-gas phase changes are not practical for use as thermal storage due to the large volumes or high pressures required to store the materials when in their gas phase. Liquid-gas transitions have a higher heat of transformation than solid-liquid transitions. While, solid-solid phase changes are typically very slow and have a rather low heat of transformation.

Initially, solid-liquid PCMs behave like sensible heat storage (SHS) materials; their temperature rises as they absorb heat. Unlike conventional SHS, however, when PCMs reach the temperature at which they change phase (their melting or “phase transition” temperature) they absorb large amounts of thermal energy at an almost constant temperature. The PCM absorbs heat with a minimal rise in temperature until all the material is transformed to the liquid phase. When the ambient temperature around a liquid material falls, the PCM solidifies, releasing its stored latent heat and maintains its phase transition temperature until the PCM transitions to a solid. These properties make PCMs well suited for providing either sports protective system heating or cooling provided that the PCM temperature(s) is/are properly chosen.

The best-known phase change material is water, which can exist as either liquid or ice at 32° F. (0° C.) at normal pressures. Certain properties of water/ice, however, may render it of little use (or useless) in given applications. With water/ice the phase temperature cannot be modified (ice is too cold to be used for most biological applications, for instance, as applying ice to tissue quickly results in vasoconstriction and vastly reduced capillary blood flow), the water-to-ice transition results in a volumetric expansion of ˜9% making it a challenge to use in mechanical applications, and ice exhibits little mechanical “give” in its fully frozen state. While the 9% expansion would likely have little impact on usability in a protective garment (it is possible to design containment systems that can gracefully handle this expansion) the low temperature is problematic for use close to the body.

Other PCMs can be either organic or inorganic, can be chemically stable or unstable, can be caustic or non-caustic, flammable/inflammable, toxic or not, dielectric or not, and the like. In short, like any other substances, PCM chemical properties vary as a function of the specific substance. PCMs are typically characterized by their Heat of Fusion (measured in kJ/kg), the amount of energy required to melt one kilogram of the material, and the Duration Index [measured in Joules/(cubic centimeter*degrees Centigrade)], which provides a basis of comparison of how long a PCM will remain at a constant temperature during its phase change.

Common PCMs include paraffins (alkanes), salt hydrates, eutectic compounds, fatty acids and esters (including animal and vegetable fats) and others. Individual PCMs will suggest themselves over others depending on the user's specific use requirements. Some PCMs transition sharply (at a given temperature), whereas others (especially with impurities) do so over a several degree temperature range with reduced heat capacity. Others lose the capacity to transition sharply after a certain number of uses (eutectics often degrade after a few thousand cycles, rendering them of little use in most applications). Some PCMs are highly flammable, while some are not. Some PCMs are highly toxic, while some are non-toxic. In general, however, PCMs can be useful as thermal energy storage media provided their other chemical properties are consistent with a given application. Of particular interest in using PCMs that are disposed proximal to the body is ensuring they are not caustic or toxic and cannot cause damage to skin or organs if a sharp blow, bullet, or shrapnel causes the PCM containment structure to leak onto or into the wearer's body. In addition, if a PCM is fully dielectric, such leaking cannot cause inadvertent flow of electricity that may damage a piece of computer or electronic equipment protected by the present microclimate system or risk further injury to personnel carrying such equipment.

What is needed is a means to create an appropriate personal microclimate without adversely affecting the force impact integrity of the protective system. The disclosed system and method enhance protective armor systems with a microclimate system comprising suitably encapsulated cooling or heating material(s) that may be fine-tuned to specific applications and ambient conditions, and is capable of providing either specific microclimate temperatures and/or cooling/heating periods. It provides such beneficial microclimate functionality while concurrently contributing additional force impact protection to the wearer as will be further described in detail below.

### BRIEF SUMMARY OF THE INVENTION

The present invention comprises a system and/or method that have one or more of the following features and/or steps, which alone or in any combination may comprise patentable subject matter.

According to one embodiment of the present invention, an impact absorbing microclimate managed protective system comprising a plurality of cells independently having one or more sizes and shapes, wherein each of the plurality of cells comprises a momentarily deformable high modulus material and each of the plurality of cells contains its own cooling or warming material.

Another embodiment of the present invention may further comprise a protective garment having at least one pocket disposed on an inner surface of the protective garment, wherein the at least one pocket has an opening allowing for insertion and removal of the plurality of cells carried within the at least one pocket.

Still another embodiment of the present invention may further comprise a protective garment, wherein the plurality of cells is integrally disposed on an inner surface of said protective garment.

Yet still another embodiment of the present invention may further comprise a protective system capable of absorbing at least a portion of an impact force while also thermo-regulating electronic equipment.

One aspect of the present invention is to provide an impact-absorbing protective system. The system may comprises a plurality of cells of one or more sizes and shapes, each cell comprised of a momentarily deformable high modulus material and each cell containing its own incompressible cooling or warming material, hereinafter called “cw material.” As detailed below, portions of the plurality of cells may be contiguous or separated and may be fully sealed from one another and/or may include baffles that communicate cw material to one another under specific circumstances. In this manner, the impact absorbing characteristics of the impact absorbing system can be optimized to the applications at hand.

Another aspect of the present invention is to provide an impact-absorbing protective garment used to protect select portions of the body, wherein the garment may comprise a plurality of baffled and/or sealed momentarily deformable cells, each cell containing a quantity of cw material, coupled as appropriate to one or more of the following elements as is needed to optimize the mitigation of impact forces associated with the force regime of a given function: (a) a middle layer comprising an impact absorbing layer system comprising one or more layers of material, such as Kevlar or compressible foam, (b) an outer shell layer covering substantially all of the selected area of the body being protected, adapted to cover the middle layer, the outer shell layer comprising a plurality of plate elements, this plurality of plate elements being positioned and arranged to cover selected portions of the body such that an effective protective shell is formed, wherein the outer shell layer comprises a stiff, shock-resistant lightweight material and having a fastener connecting the outer layer to the middle layer; and (c) a conforming interface layer or layers on a plurality of cells.

A further aspect of the present invention is to provide an impact-absorbing protective garment used to provide both force impact protection and localized microclimate management to critical electronics or other inanimate equipment, especially those whose continuous operational capacity are essential to support mission requirements.

### BRIEF DESCRIPTION OF THE DRAWINGS

The accompanying drawings, which are incorporated into and form a part of the specification, illustrate one or more embodiments of the present invention and, together with the description, serve to explain the principles of the invention. The drawings are only for the purpose of illustrating the preferred embodiments of the invention and are not to be construed as limiting the invention. In the drawings:

FIG. 1 depicts a front view of a garment or vest embodiment of the present invention, showing a partial view of the rear interior section along with straps that may be used for attaching the vest to the torso of a wearer.

FIG. 2 depicts a front view of a conventional bullet-resistant vest.

FIG. 3 depicts an interior view of the bullet resistant vest of FIG. 2, wherein the vest has been enhanced with an open mesh pocket for containing a preferred embodiment of a microclimate system of the present invention.

FIG. 4 depicts a front transparent view of the bullet resistant vest of FIG. 2, wherein a preferred embodiment of a microclimate system of the present invention is shown being worn directly underneath the bullet resistant vest.

FIG. 5 depicts a perspective view of a preferred embodiment of a protective microclimate sheathing system of the present invention disposable about an electronic device such as a tactical radio as shown.

### DETAILED DESCRIPTION OF THE INVENTION

The following documentation provides a detailed description of the invention.

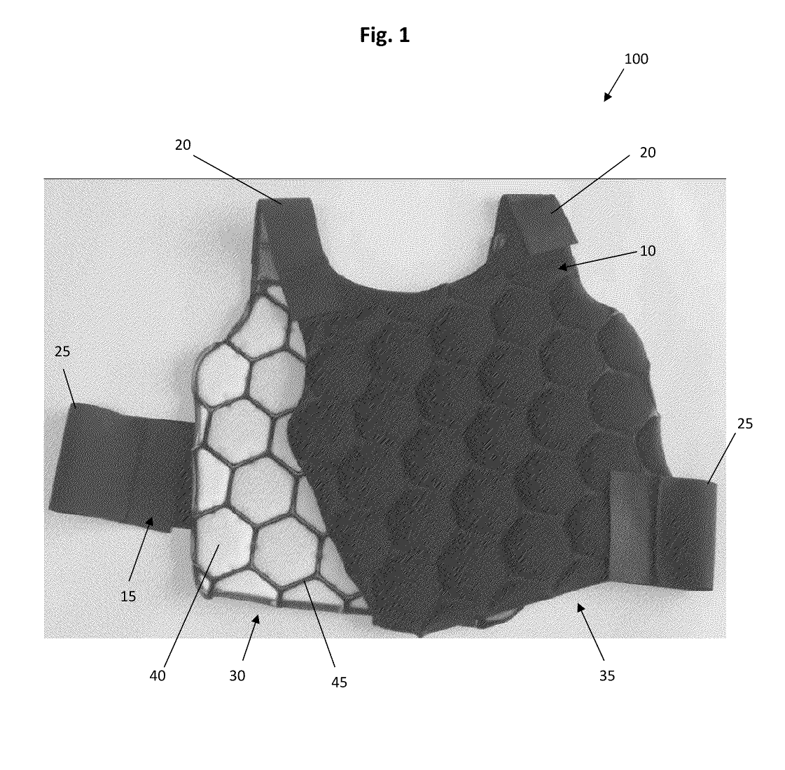

Referring to the drawings now in detail, reference is first made to FIG. 1, wherein an impact protective microclimate-managing vest 100 is shown in a “stand-alone” or “sub-garment” format. The outer surface of the vest 100 may be covered with loop material 10 such as that marketed under the trade names VELTEX or VELCRO by Velcro Industries to which hook fasteners 15 such as those marketed under the trade name VELCRO by Velcro Industries may be firmly fixed to secure the vest 100 to a wearer. Shoulder elements 20 and/or waist elements 25 may provide releasable connections for securing the front and rear sections of the vest 100 about the wearer. The inside surface of the rear section 30 of the vest 100 may comprise a plurality of cells 40 formed of a suitable high strength and high modulus material such as films known within the art including but not limited to urethane, propylene, ethylene, members of an olefin family, and the like, encasing an incompressible cooling or warming liquid (hereinafter ‘cw material’) that is selected for effecting cooling or heating of the area of the body that it confronts. The high modulus material may comprise a thickness in the range of 0.002 inches to 0.100 inches. In a preferred embodiment, as shown in FIG. 1, the plurality of cells 40 may comprise a plurality of hexagonal-shaped cells, but the scope of the present invention includes a plurality of cells 40 comprising any shapes known within the art.

The plurality of cells 40 may also be fused to a fabric or a compressible foam layer, wherein the fabric or the compressible foam layer may be capable of transmitting a lateral shockwave in response to an impact to further distribute the shock energy resulting from a deformation of at least one of the plurality of cells 40 even if at least one of the plurality of cells 40 has burst due to the impact. Each of the plurality of cells 40 may also be separated from each adjacent cell by a frangible sealing zone 45. The frangible sealing zones 45 may comprise any of several technologies capable of permanently joining together multiple layers of the cw material containing film (and fused fabric, if present) and may further include sections of lower or higher strength such that the weaker zone sections are capable of opening to adjoining cells under very high pressure.

Upon receiving significant impact against the outer surface of the vest 100, the impact force is transferred through the loop material 10 layer and into the cw material disposed within the plurality of cells 40. If the impact is sufficient, individual cells of the plurality of cells 40 may momentarily but significantly deform, helping to absorb the incident impact force. If the plurality of cells 40 is contiguous, the impact force may translate into a lateral wave further spreading the incident impact force to other cells. If the impact is yet higher, the pressure on the cw material within one or more adjacent cells of the plurality of cells 40 may exceed the binding force of one or more frangible sealing zones 45 such that the frangible sealing zones 45 subject to the impact may burst thereby allowing for the transfer of cw material from one cell to an adjacent cell in order to partially absorb such an impact. When this happens, there is a communication from one cell to another adjacent cell that would have theretofore been precluded under normal conditions due to the sealing off of adjacent cells by the frangible sealing zones 45. By combining the use of a suitable high modulus containment film for formation of the plurality of cells 40 in combination with the use of sealing/bonding technologies for creation of different burst strength frangible sealing zones 45, it is possible to fine-tune the overall capacity of the system of the present invention to absorb and dissipate incident impacts.

It will be apparent that the passages that are opened when frangible sealing zones 45 burst provide for communication of some cw material between one or more cells to one or more adjacent cells for dissipating absorbed energy to such adjacent cells. Frangible sealing zones 45 may comprise a resealable construction wherein a vest 100 receiving an impact force large enough to break at least one frangible sealing zone 45 may thereafter have such frangible sealing zone(s) 45 reformed or resealed allowing the present inventive vest 100 or other garment to be repairable and/or reusable in nature.

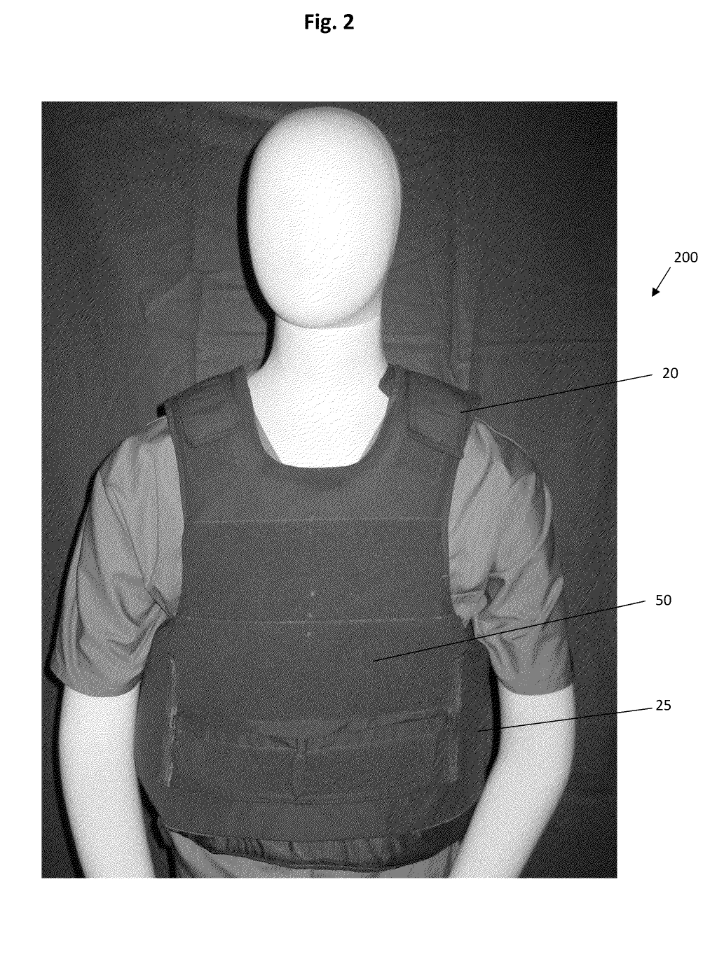

FIG. 2 depicts a frontal view of a conventional bullet resistant vest 200 comprising lightweight material encasing multiple layers of protective material such as that sold under the trade name KEVLAR (not shown). The conventional bullet resistant vest 200 may further comprise frontal attachment strips 50 of the loop material such as that marketed under the trade names VELTEX or VELCRO by Velcro Industries to which hook fasteners 15 such as those marketed under the trade name VELCRO by Velcro Industries may be firmly fixed to secure the conventional bullet resistant vest 200 to a wearer. The conventional bullet resistant vest 200 may further comprise shoulder elements 20 and waist elements 25, which may be used to connect the front and rear sections of the conventional bullet resistant vest 200.

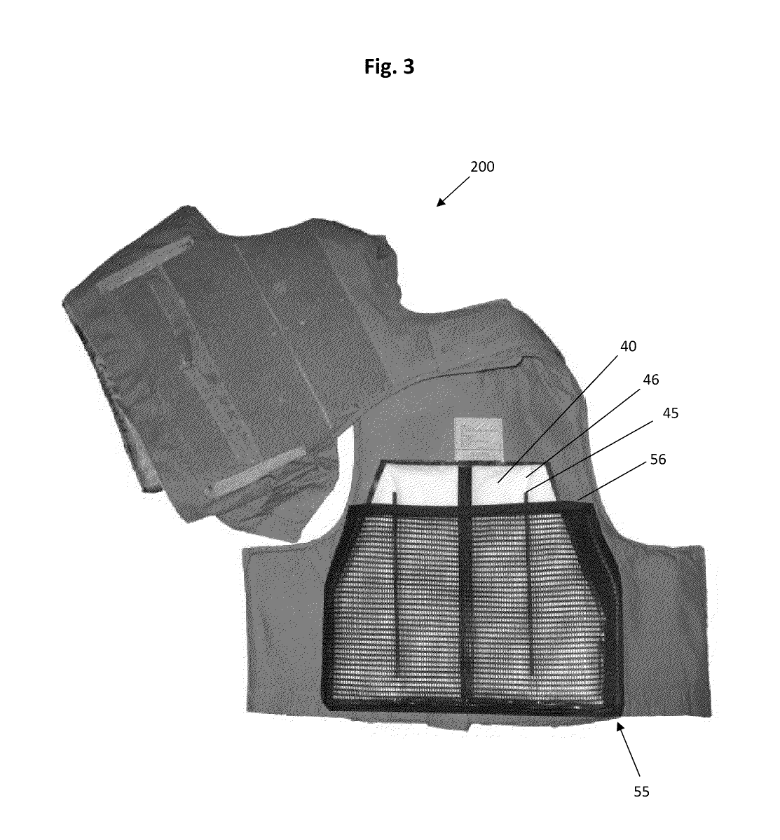

FIG. 3 depicts one embodiment of a system of the present invention wherein a plurality of cells 40 is incorporated into a conventional bullet resistant vest 200. The inner surface of the front and/or rear section of the conventional bullet resistant vest 200 may comprise at least one pocket 55 or pouch attached thereto. In a preferred embodiment, the pocket 55 may be constructed of a lightweight open-pore mesh material and may further comprise an opening 56 or mouth slit along the upper edge of the pocket 55. The pocket 55 is preferably stitched to the inner surface of the front or rear section of the conventional bullet resistant vest 200, but the scope of the present invention includes all fixation means known within the art including but not limited to stitching, hook and loop fasteners, rivets, and the like.

The pocket 55 may hold and releasably retain a plurality of cells 40 containing cw material, wherein the plurality of cells 40 may be formed of a suitable high strength and high modulus material encasing the cw material that may be selected for effecting cooling or heating of the area of the wearer's body portion that it confronts. Each of the plurality of cell 40 may be separated from adjacent cells by frangible sealing zone 45 and/or open channels 46 that may provide for communication of at least a portion of cw material between one or more adjacent cells. The combination of frangible sealing zones 45 and the open baffles created by one or more open channels 46 forms a tuned impact force transference network having different characteristics than would be achieved if only frangible sealing zones 45 completely separated each of the plurality of cells 40.

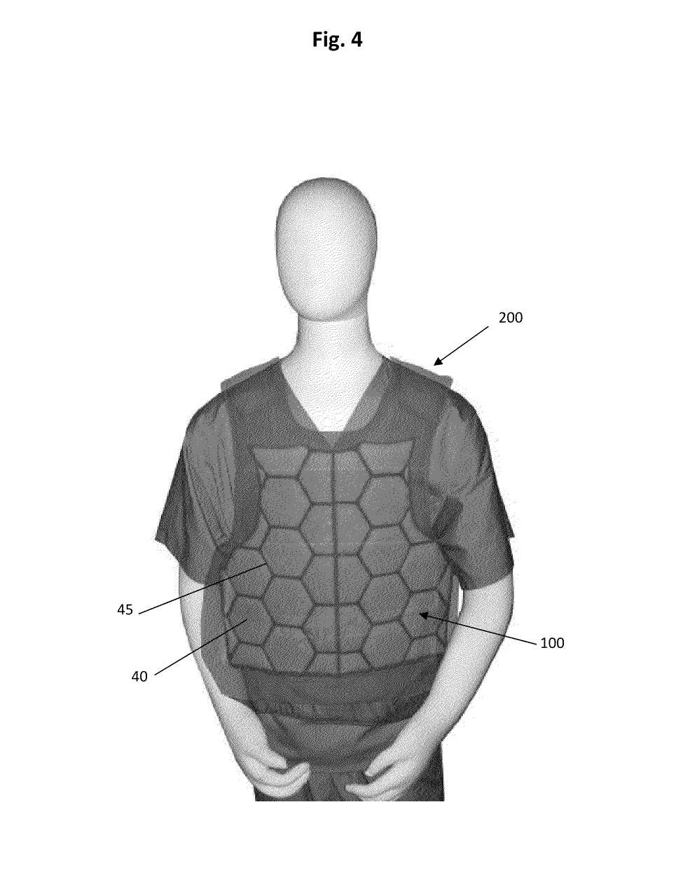

FIG. 4 depicts a front transparent view through a conventional bullet resistant vest 200. As shown, the wearer may first don an impact protective microclimate-managing vest 100 similar to the embodiment depicted in FIG. 1 as a first inner layer and thereafter the wearer may don a conventional bullet resistant vest 200 as an outer layer disposed atop the impact protective microclimate-managing vest 100. This combination shows that effective microclimate and force impact protection can be used to augment already existing commercial protective garments such as a conventional bullet resistant vest 200, permitting users to enjoy the many benefits of the present invention at low overall cost since it may be readily and easily put to use with prior art protective gear as shown herein. When the plurality of cells 40 comprises the most preferred embodiment having hexagonal-shaped cells, the wearer suffers virtually no reduction in flexibility or mobility as compared to the stand-alone use of commercial protective garment such as a conventional bullet resistant vest 200. While not shown, an alternate embodiment may further comprise a contained layer of gel that may be contained in a plurality of cells and be disposed between the wearer and the impact protective microclimate-managing vest 100 to achieve the one or more temperatures of the cw material and also form a soft interface layer with the wearer.

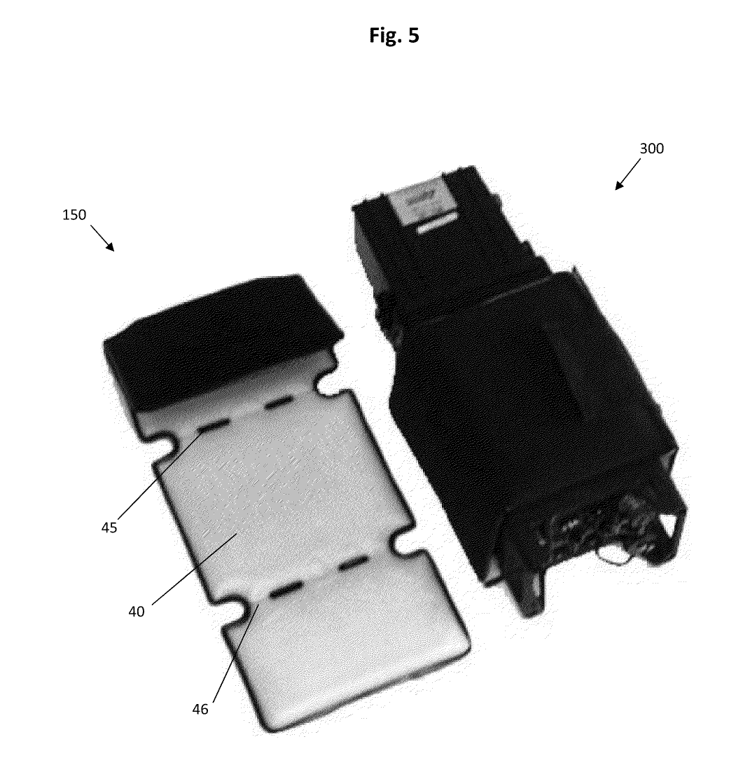

FIG. 5 depicts an impact protective microclimate-managing protective system 150 in use to absorb impact force and provide a microclimate for computer or electronic equipment 300 such as a tactical radio. The outer surface of the system 150 may be covered by loop material such as that sold under the trade name VELTEX or VELCRO that is fused to the plurality of cells 40, wherein hook fasteners such as those sold under the trade name VELCRO may be used to firmly wrap the protective system 150 around the electronic equipment 300 and provide a releasable connection to the loop material. The plurality of cells 40 may contain cw material and may be formed from a high strength and high modulus material that encases the cw material wherein the cw material may be specifically selected for effecting cooling or heating of the inanimate object or electronic equipment 300 it confronts. When protecting electronic equipment 300, the cw material may provide a phase transition point within the range of 91 degrees Fahrenheit to 300 degrees Fahrenheit. Each of the plurality of cells 40 may be separated from each adjacent cell by frangible sealing zones 45 and/or one or more open channels 46 wherein each may allow for communication of at least a portion of cw material between adjacent cells when the system 150 is struck. The combination of frangible sealing zones 45 or porous sealing zones and the open baffles created by one or more open channels 46 form a tuned impact force transference network with different characteristics than would be achieved if only frangible sealing zones 45 separated each of the plurality of cells 40. While not shown, an alternate embodiment may further comprise an additional interface layer comprising a suitable high strength material such as urethane or polymer film encasing a strong, flat, high thermal conductance material such as aluminum or other suitable metal, ceramic, or plastic. The additional interface layer may be disposed between the plurality of cells 40 containing cw material and the electronic equipment 300 or other inanimate object to affect maximum thermal transfer by ensuring that a maximally flat surface confronts or contacts the inanimate object.

While the embodiments illustrated herein have included frangible sealing zones 45 between individual cells, it is understood that micro-porous seals or seals made by combining multiple material types or technologies which together may result in individual seals of specific varying strengths may be interchanged with, used alone, or used in combination with frangible sealing zones 45 and/or a plurality of open baffles created by one or more open channels 46, wherein the cw material containment and distribution system enables the plurality of cells 40, the sealing zone configuration, and/or one or more open channels 46 to dissipate and propagate incident force impact in different manners.

The present invention may comprise a plurality of shock mitigating cells 40 that may take the form of one or more layers, wherein each of the plurality of cells 40 contains some amount of cw material that establishes a personal microclimate system for the wearer or electronic equipment. The vest or garment embodiment of the microclimate system may be capable of being worn absent other shock absorbing protective gear (as shown in FIG. 1) or in combination with such additional gear (such as bullet resistant vest 200 shown in FIGS. 2-4), wherein the system may be either loosely coupled or fully integrated with the associated protective garb/system. The personal microclimate system may be placed directly next to the skin or over a thin layer of clothing of the wearer and is designed to create a microclimate temperature that affords both greater wearer comfort and mitigates localized deleterious impacts on physical and mental stamina while simultaneously attenuating force impact by synergistically combining with all other protective garment system elements that may be present thereby enhancing the protective armor's overall force impact performance.

In one embodiment as shown in FIG. 1, a microclimate system of the present invention may be worn absent other personal armor, affording a managed temperature microclimate with a reasonable level of force impact protection to a wearer or piece of electronic equipment 300 (see FIG. 5).

In another embodiment of the personal microclimate system of the present invention, the plurality of cells 40 may be constructed from only materials that are non-toxic and/or have third party certification of component non-toxicity.

In still another embodiment of the microclimate system of the present invention, the plurality of cells 40 may contain cw material that is dielectric and non-conductive of electricity.

In still yet another embodiment of the personal microclimate system of the present invention as shown in FIG. 3-4, the system may be designed as an effective upgrade or enhancement to existing armor systems such as bullet proof vests and may be loosely coupled to the inside of the armor or worn separately underneath the armor. The wearer may don the microclimate system using attachment straps, hook and loop fasteners, clips or any other means known within the art, wherein the system is worn directly next to the body of the wearer on the section of the body that will be covered by the armor. The armor may then be fitted over the microclimate system. In an alternate embodiment, for example, flak jackets or lead vests used as x-ray or radiation shields for patients may have a personal microclimate system of the present invention integrated directly into the armor system by way of one or more sculpted or fixed pockets and/or one or more open mesh containment pockets on the inner surface of the armor wherein the personal microclimate system is held within the pockets in direct communication with the wearer's body. By such placement against the wearer's body, the personal microclimate system effectively creates a constant temperature environment while suffering the lowest amount of performance hysteresis. In embodiments where the personal microclimate system is not integrally constructed with a conventional armor system, the personal microclimate system may be quickly removed and replaced with another charged unit/system thereby making it possible for the wearer to comfortably use the armor system for extended periods of time. As is apparent to anyone skilled in the art, any number of techniques known within the art may be used to integrate the personal microclimate system layer into conventional armor systems, some of which are described below.

The personal microclimate system may comprise multiple layers that may include one or more of the following: (1) flexible, resilient, impact-resistant layers of tri-polymer plastic or other known materials such as urethanes, ethylenes, propylenes, or the like exhibiting superior physical ‘memory’, strength and workability, formed into a plurality of impact resistant cells 40 of one or more sizes, shapes and/or thicknesses, wherein the plurality of cells 40 themselves may be designed and specifically placed to balance the characteristics of physical flexibility and fluidity of movement, comfort, volumetric capacity, force impact performance, anti-microbial performance, durability and cleanability; (2) an application appropriate cw material disposed within the plurality of cells 40; (3) attachment materials or other means known within the art including but not limited to hook and loop fasteners, loop material 10 or other hook 15 attachments sold under the brand name VELTREX or VELCRO, and/or material and/or mesh pockets enabling the use of various anchor attachment straps or other mechanical mounting and holding provisions that help provide a definitional barrier that assists in defining the overall shape of this stratum; (4) an energy absorbing stratum or liner system that is created from specifically chosen models of the polymeric visco-elastic family of foams sold by Team Wendy under the trade name ZORBIUM or similar anti-ballistic foam materials that may be sculpted out to properly locate or attach the personal microclimate system, wherein the material's modulus characteristics may be optimized to give a protective armor system further enhanced means to shield against relevant high and low speed force impacts beyond those already afforded by the microclimate system; and (5) a fully contained layer of gel lying intimately upon or being fused to the inner surface of the plurality of cw material containing cells 40, wherein the contained gel layer achieves the cw material's temperature and also serves as a physically soft interface between the wearer and the plurality of cells 40.

In a preferred embodiment of the present invention, the cw material may comprise an alcohol based gel or a PCM. A preferred embodiment may comprise a PCM system that may incorporate a single-phase change material transition (or phase) point, whether intended to provide warming (for instance, in very cold ambient environments) or cooling (in warmer ambient environments when overheating is a relevant risk). In yet another embodiment, with appropriate design or formulation, the PCM system may offer from two to ten specifically chosen, stable temperature transition points. In still yet another embodiment, the present invention may uniquely provide a single transition temperature that is not possible with conventional prior art PCMs. In this way a garment (e.g. vest) or armor may comprise a specific personal microclimate phasing which, itself, depends on both ambient and wearer conditions. Preferably, the one or more phase transition points may have a tolerance of plus or minus ten (10) degrees Fahrenheit. Most preferably, the one or more phase transition points may have a tolerance of plus or minus one (1) degree Fahrenheit.

Other properties of specific PCMs that may enhance utility in a protective armor and/or microclimate system application featured in other embodiments may include but are not limited to (a) the capacity to undergo any number of thermal cycles without notable degradation, (b) the capacity to provide a relatively constant temperature microclimate for a long duration (a high Duration Index), (c) the chemical property of not being harmful or caustic to skin or organs (as determined, for instance from Material Safety Data Sheets), and (d) certification for such safety (such as an FDA 510(k)). One such family of PCMs is marketed under the trade name HTFEXOTHERM® by HTFx Inc. Embodiments incorporating properties (c) and/or (d) will enhance overall wearer safety even in the event of destructive trauma to at least one of the plurality of cells 40.

When using a contained incompressible cw material, whether in the somewhat hardened charged state or in the fully discharged liquid state, the cw material contributes directly to the protective armor's dissipation or dampening of force impact energy by momentarily deforming its containment cells 40. In this manner the cw material and plurality of cells 40 assist in propagating a lateral wave to other cells that also deform and absorb energy further protecting the wearer from force trauma. The personal microclimate systems of the present invention are designed to augment, rather than degrade, the protective properties of any armor system into which the present inventive microclimate system is incorporated. In preferred embodiments, these protective characteristics are dramatically amplified by containing the cw material within either a plurality of cells 40 that may be formed from any physically malleable materials known within the art such as tri-polymer films or in a plurality of cells 40 designed to release or transfer cw material (e.g. PCM fluid) from cell to cell when one or more of the plurality of cells 40 experiences a high hydroscopic pressure such as that caused by a force impact (whether localized or spread). This quality can be obtained by varying the shape, size, and/or placement of the plurality of cells 40, by selecting one or more material sealing technologies such as thermal impulse sealing and RF sealing, and/or by including one or more open channels 46, wherein the one or more open channels 46 may comprise a variety of widths between cells (whether these channels are always open or some are forced open only by a high impact force) to adjust the strength and reactivity of the cell walls. This approach may be used quite effectively to create a system of small scale “baffles” between adjacent cells making it possible to beneficially further disburse and dampen force impact shock waves across the plurality of cells 40 and to create a system responsive to both high and low speed force impacts. This macroscopic quality may be maintained even when the incident force is high enough to damage one or more cells. Absent a force impact, the cw material may remain relatively static within the plurality of cells 40.

Different embodiments may use different combinations of film material, number, shape (including the use of one or many different shapes simultaneously), size (including the use of one or many sizes simultaneously), placement of the plurality of cells 40, and different cell sealing technologies to form a variety of effective systems that may comprise microclimate managed protective system control that provides for force dispersal and dampening that may be incorporated into protective garments or other human or equipment armor systems.

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not merely by the preferred examples or embodiments given.

What is claimed is:

1. An impact absorbing microclimate managed protective system, comprising:
a plurality of cells independently having one or more sizes and shapes, wherein each of said plurality of cells comprises a momentarily deformable high modulus material and each of said plurality of cells contains its own cooling or warming material.

2. The impact absorbing protective system of claim 1, wherein said momentarily deformable high modulus material comprises a film selected from the group consisting of urethane, propylene, ethylene, and a member of an olefin family.

3. The impact absorbing protective system of claim 1, wherein said momentarily deformable high modulus material comprises a thickness in the range of 0.002 inches to 0.100 inches.

4. The impact absorbing protective system of claim 1, wherein said plurality of cells is fused to a fabric or a compressible foam layer, wherein said fabric or said compressible foam layer is capable of transmitting a lateral shockwave in response to an impact further distributing shock energy resulting from a deformation of at least one of said plurality of cells even if at least one of said plurality of cells has burst due to said impact.

5. The impact absorbing protective system of claim 1, wherein each of said plurality of cells are separated by at least one frangible sealing zone, wherein said at least one frangible sealing zone is capable of attenuating shock energy from an impact by allowing at least a portion of said cooling or warming material to pass across said at least one frangible sealing zone when a predetermined impact force is applied to at least one of said plurality of cells and by providing at least one passage for communicating at least a portion of said cooling or warming material from a first cell of said plurality of cells to a second cell of said plurality of cells for dissipating said shock energy from said predetermined impact force.

6. The impact absorbing protective system of claim 1, wherein each of said plurality of cells are separated by at least one minutely porous sealing zone, wherein said at least one minutely porous sealing zone is capable of attenuating shock energy from an impact by allowing at least a portion of said cooling or warming material to pass across said at least one minutely porous sealing zone when a predetermined impact force is applied to at least one of said plurality of cells and by providing at least one passage for communicating at least a portion of said cooling or warming material from a first cell of said plurality of cells to a second cell of said plurality of cells for dissipating said shock energy from said predetermined impact force.

7. The impact absorbing protective system of claim 1, wherein said plurality of cells are separated by a baffling system comprising both frangible sealing zones or minutely porous sealing zones and one or more open channels, wherein various configurations of said baffling system are capable of adjusting the impact absorbing properties of said impact absorbing protective system.

8. The impact absorbing protective system of claim 1, wherein at least one of said plurality of cells is hexagonal in shape.

9. The impact absorbing protective system of claim 1, wherein said cooling or warming material comprises an alcohol based gel.

10. The impact absorbing protective system of claim 1, wherein said cooling or warming material comprises a phase change material, said phase change material comprising one or more components selected from the group consisting of an alkane, a paraffin, salt hydrates, eutectic compounds, fatty acids, esters, animal fats, vegetable fats, and water.

11. The impact absorbing protective system of claim 1, wherein said cooling or warming material comprises a phase change material and said phase change material provides a plurality of phase transition points.

12. The impact absorbing protective system of claim 1, wherein said cooling or warming material comprises a phase change material and said phase change material provides one phase transition point.

13. The impact absorbing protective system of claim 1, wherein said cooling or warming material comprises a phase change material and said phase change material provides at least one phase transition point with a tolerance of plus or minus one degree Fahrenheit.

14. The impact absorbing protective system of claim 1, wherein said cooling or warming material comprises a phase change material and said phase change material provides at least one phase transition point with a tolerance of plus or minus ten degrees Fahrenheit.

15. The impact absorbing protective system of claim 1, wherein said cooling or warming material comprises a phase change material and said phase change material is non-toxic to human beings.

16. The impact absorbing protective system of claim 1, further comprising:
a contained layer of gel, wherein said contained layer of gel is disposed on an inner surface of said plurality of cells and said contained gel layer is disposed against the body of a user when in use wherein said contained gel layer is capable of achieving one or more temperatures of said cooling or warming material and providing a physically soft interfacing layer to said user.

17. The impact absorbing protective system of claim 1, further comprising:
a protective garment having at least one pocket disposed on an inner surface of said protective garment, wherein said at least one pocket has an opening allowing for insertion and removal of said plurality of cells carried within said at least one pocket.

18. The impact absorbing protective system of claim 17, wherein said protective garment is selected from the group consisting of a bullet proof vest, a flak jacket, and a lead apron.

19. The impact absorbing protective system of claim 1, further comprising:
a protective garment, wherein said plurality of cells is integrally disposed on an inner surface of said protective garment.

20. The impact absorbing protective system of claim 1, wherein said impact absorbing protective system is capable of protecting electronic equipment.

21. The impact absorbing protective system of claim 20, wherein said cooling or warming material provides a phase transition point within the range of 91 degrees Fahrenheit to 300 degrees Fahrenheit.

22. The impact absorbing protective system of claim 20, wherein said cooling or warming material is dielectric.
